(19) United States
(12) Patent Application Publication
(10) Pub. No.: US 2009/0015135 A1
(43) Pub. Date: Jan. 15, 2009

(54) LIGHT EMITTING DEVICE

(75) Inventors: Masami Aihara, Miyagi-ken (JP); Makio Naito, Miyagi-ken (JP); Hiroya Abe, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/211,362

(22) Filed: Sep. 16, 2008

Related U.S. Application Data
(63) Continuation of application No. PCT/JP2007/054889, filed on Mar. 13, 2007.

(30) Foreign Application Priority Data
Mar. 28, 2006 (JP) 2006-089026

(51) Int. Cl. H01J 1/62

(52) U.S. Cl. 313/498

(57) ABSTRACT

A semiconductor light emitting element which is primarily composed of GaN and which emits blue light is provided with a fluorescent layer, and the fluorescent layer includes fluorescent particles formed of a YAG fluorescent substance. By synthesis between yellow light emitted from the fluorescent particles and the blue light, white light is obtained. Fine particles, such as silica, adhere to the peripheries of the fluorescent particles forming the fluorescent layer, and between the particles, air layers are formed. The air layers each function as a heat insulating layer and can suppress an increase in temperature of the fine particles when an environmental temperature is increased. Hence, luminous efficiency of the fluorescent particles is not likely to vary, and the change in luminescent color can be suppressed.

### CLAIM OF PRIORITY

This application is a continuation of International Application No. PCT/JP2007/054889, filed Mar. 13, 2007, which claims benefit to the Japanese Patent Application No. 2006-089026 filed on Mar. 28, 2006, both of which are incorporated herein by reference in their entirety.

### BACKGROUND OF THE INVENTION

1. Field of the Invention

The present invention relates to a light emitting device including a semiconductor light emitting element and fluorescent particles emitting light by light emitted from this semiconductor light emitting element.

2. Description of the Related Art

A light emitting device, called a white LED, formed in order to emit white base light includes a blue LED chip in combination with a fluorescent substance emitting yellow light.

The blue LED chip is formed of a p-n junction chemical semiconductor which primarily includes gallium nitride (GaN), and when a forward current is supplied to the chip, for example, blue base light having a wavelength of 560 nm or less is emitted therefrom. The fluorescent substance emits yellow light using the light emitted from the blue LED chip as exciting light, and an yttrium aluminum garnet (YAG) fluorescent substance is generally used.

A white LED emits white base light generated by synthesis between blur light and yellow light complementary thereto. This white LED is not only able to reduce power consumption by approximately 30% compared to that of a fluorescent lamp but is also superior in terms of environmental adaptation since it uses no mercury unlike a fluorescent lamp. Accordingly, a white LED starts to be used for a backlight for various display devices and for a simple lighting apparatus (for example, see Japanese Unexamined Patent Application Publications Nos. 2005-41941 and 2005-41942).

### SUMMARY OF THE INVENTION

The above YAG fluorescent substance is a substance which absorbs light emitted from a blue LED chip and is excited thereby to emit yellow light; however, the luminous efficiency by a fluorescent effect depends on a use environmental temperature, and in particular at an environmental temperature of approximately 100° C. or more, the luminous efficiency is seriously decreased. On the other hand, since a white LED is desired to have a higher output of the quantity of light to be emitted, an electric power applied to a blue LED tends to be increased. Hence, the temperature is increased when a blue LED is emitting light, and the luminous efficiency of a YAG fluorescent substance is liable to be decreased. When the luminous efficiency of a YAG fluorescent substance is decreased, the balance between the quantity of light emitted therefrom and the quantity of light emitted from a blue LED chip cannot be maintained, and the wavelength of light emitted from a white LED is liable to shift to a blue color side. As a result, for example, when a white LED is used for a backlight of a display device, unfavorably, the balance of color to be displayed by the display device is not maintained.

Furthermore, when the luminous efficiency of a YAG fluorescent substance is decreased by an increase in temperature thereof, and a blue color component emitted from a blue LED chip is increased, the color temperature of light obtained by synthesis with light emitted from a YAG fluorescent substance is increased, and bluish light having a cold feeling starts to be emitted from a white LED, so that this type of white LED is not easily used as a lighting apparatus.

The present invention has been conceived to solve the above-described problems and provides a light emitting device which can suppress a decrease in luminous efficiency of a fluorescent substance when a use environmental temperature is increased and which can suppress a significant change in luminescent color obtained by synthesis between color of light emitted from a semiconductor light emitting element and color of light emitted from a fluorescent substance.

According to the present invention, there is provided a light emitting device including: a semiconductor light emitting element; electrodes supplying electricity to the semiconductor light emitting element; and a fluorescent layer covering a light emitting side of the semiconductor light emitting element. In the above light emitting device, the fluorescent layer includes: fluorescent particles emitting light by light emitted from the semiconductor light emitting element; transparent fine particles which adhere to the outsides of the fluorescent particles, and air layers formed between the fluorescent particles and the fine particles and between the fine particles.

In the light emitting device according to the present invention, the fine particles adhere to the outsides of the fluorescent particles, and the air layers (which are preferably air layers each forming a perfectly sealed closed space) are formed around the fluorescent particles. Since the air layers each function as a heat insulating layer, even when the use environment temperature is increased, an increase in temperature of the fluorescent particles can be suppressed, and a decrease in luminous efficiency thereof can be suppressed. Hence, the variation in luminescent color obtained by synthesis between the color of light emitted from the semiconductor light emitting element and the color of light emitted from the fluorescent particles can be suppressed.

The air layers preferably have a spatial length of 100 nm or less. Since the mean free path of nitrogen under the atmospheric pressure is approximately 100 nm or is slightly smaller than that, when the spatial length of the air layer is set to be smaller than the above free mean path, the heat insulating effect of the air layer can be enhanced. In addition, the spatial length of the air layer is more preferably 80 nm or less.

In addition, the fluorescent particles provided with the fine particles which adhere to the outsides thereof preferably agglomerate in at least a part of the fluorescent layer.

Since a plurality of fluorescent particles is made to agglomerate, temperature transmission efficiency to the fluorescent particles is decreased, and when the use environment temperature is increased, an increase in temperature of each fluorescent particle can be more easily suppressed.

In addition, according to the present invention, for example, the fluorescent layer preferably further includes a transparent synthetic resin besides the fluorescent particles and the fine particles. The synthetic resin described above includes, for example, an epoxy resin, a polyallylamine (PAA), and a silicone resin.

In addition, according to the present invention, with an intermolecular bonding force generated by applying mechanical energy, preferably, the fluorescent particles and the fine particles are bonded together, and the fine particles are bonded to each other.

For example, according to the present invention, preferably, the semiconductor light emitting element emits blue light, and the fluorescent particles emit yellow light.

In the light emitting device according to the present invention, even when the use environment temperature is increased, the balance of luminescent color is not likely to be degraded. In addition, even when the use environment temperature is increased, an increase in color temperature of emitted light can be suppressed.

### BRIEF DESCRIPTION OF THE DRAWINGS

FIG. 1 is a cross-sectional view showing a light emitting device according to an embodiment of the present invention;

FIG. 2 is an enlarged cross-sectional view showing a semiconductor light emitting element used in the light emitting device of the above embodiment;

FIG. 3 is a schematic view showing the state in which fluorescent particles and fine particles agglomerate;

FIG. 4 is a schematic view illustrating the state in which the fine particles adhere to the periphery of one fluorescent particle;

FIG. 5 is a schematic enlarged view illustrating the state in which five layers of the fine particles adhere to the periphery of one fluorescent particle;

FIG. 6 is a chromaticity diagram showing evaluation results by an evaluation method A;

FIG. 7 is a chromaticity diagram showing evaluation results by an evaluation method B; and

FIG. 8 is an illustration view relating to the chromaticity diagrams shown in FIGS. 7 and 8.

### DESCRIPTION OF THE PREFERRED EMBODIMENTS

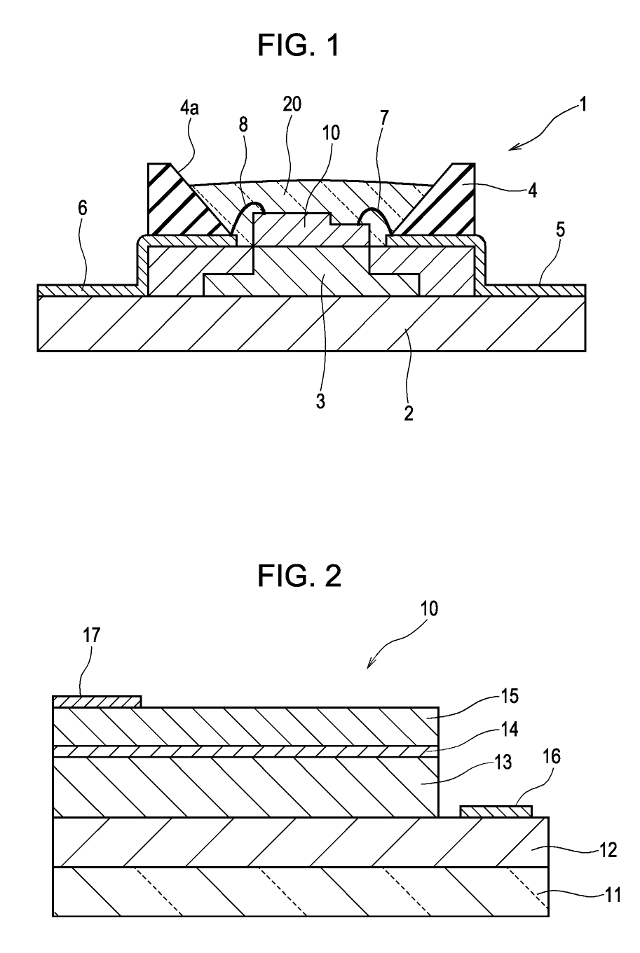

FIG. 1 is an enlarged cross-sectional view showing a light emitting device 1 according to an embodiment of the present invention, and FIG. 2 is an enlarged cross-sectional view showing a semiconductor light emitting element 10 mounted in the above light emitting device 1.

The light emitting device 1 includes the chip type semiconductor light emitting element 10. The semiconductor light emitting element 10 is formed by a thin film process. As shown in FIG. 2, this semiconductor light emitting element 10 has a buffer layer (not shown) of gallium nitride (GaN) having a small thickness on a surface of a sapphire substrate 11, and on this buffer layer, an n-type contact layer 12 is formed. The n-type contact layer 12 is a GaN layer doped with silicon (Si), and the thickness thereof is approximately 4 μm. On the n-type contact layer 12, an n-type clad layer 13 is formed to have a close contact therewith. The n-type clad layer 13 is formed of AlGaN or is formed of AlGaN and n-type GaN doped with Si, and the thickness thereof is approximately 1.0 μm.

On a surface of the n-type clad layer 13, an active layer 14 is formed to have a close contact therewith. This active layer 14 is formed of n-type indium gallium nitride (InGaN) or is formed of a laminate film including n-type InGaN doped with Si and InGaN, and the overall film thickness thereof is approximately 400 Å. On a surface of the active layer 14, a p-type clad layer 15 is formed to have a close contact therewith. The p-type clad layer 15 is formed of aluminum gallium nitride (AlGaN) or is formed of AlGaN and GaN, and the thickness thereof is approximately 0.5 μm. Furthermore, on a surface of the p-type clad layer 15, a p-type contact layer is formed (not shown).

At one side of the semiconductor light emitting element 10, the n-type contact layer 12 is partly exposed, and on the surface of the exposed portion of the n-type contact layer 12, an n electrode 16 is formed. In addition, on the surface of the p-type contact layer, a p electrode 17 is formed at a position which is not located in a light emission region. The n electrode 16 and the p electrode 17 are each formed of Ni/Au (that is, a laminate of nickel and gold).

When a positive potential is applied to the p electrode 17 of the semiconductor light emitting element 10, and a forward current is supplied to the semiconductor light emitting element 10 having a pn-junction, free electrons, which are negative charges in the n-type clad layer 13 and free holes in the p-type clad layer 15 are recombined in the active layer 14, and by the energy generated thereby, light is emitted. The wavelength of light emitted from the semiconductor light emitting element 10 primarily formed of GaN is 530 nm or less, and light in bands from green to blue and further to ultraviolet can be emitted; however, in this embodiment, blue light having a wavelength of 160 to 470 nm is emitted.

In addition, as the semiconductor light emitting element, a transparent electrode formed of indium tin oxide (ITO) or the like may be formed as the p electrode 17 on the surface of the p-type clad layer 15 or the surface of the p-type contact layer covering the p-type clad layer 15.

In the light emitting device 1 shown in FIG. 1, a heat dissipation member 3 is provided on a surface of a package substrate 2. This heat dissipation member 3 is formed of a material, such as aluminum or copper, having a high thermal conductivity. The chip type semiconductor light emitting element 10 is disposed on a surface of this heat dissipation member 3 and is bonded thereto. The heat dissipation member 3 and the semiconductor light emitting element 10 are covered with a package material 4. This package material 4 is a heat-resistant electrical insulating material and is formed, for example, of aluminum nitride (AIN). From the surface of the package substrate 2 to the inside of the package material 4, a pair of lead terminals 5 and 6 is formed. One lead terminal 5 and the n electrode 16 of the semiconductor light emitting element 10 are connected to each other by a bonding wire 7, and the other lead terminal 6 and the p electrode 17 of the semiconductor light emitting element 10 are connected to each other by a bonding wire 8.

The package material 4 is also used as a reflector, and the surface thereof functions as a reflection surface 4a. This reflection surface 4a is formed so that an opening area thereof is gradually increased toward a light emission direction.

In addition, on the above reflection surface 4a, a fluorescent layer 20 covering the semiconductor light emitting element 10 is provided.

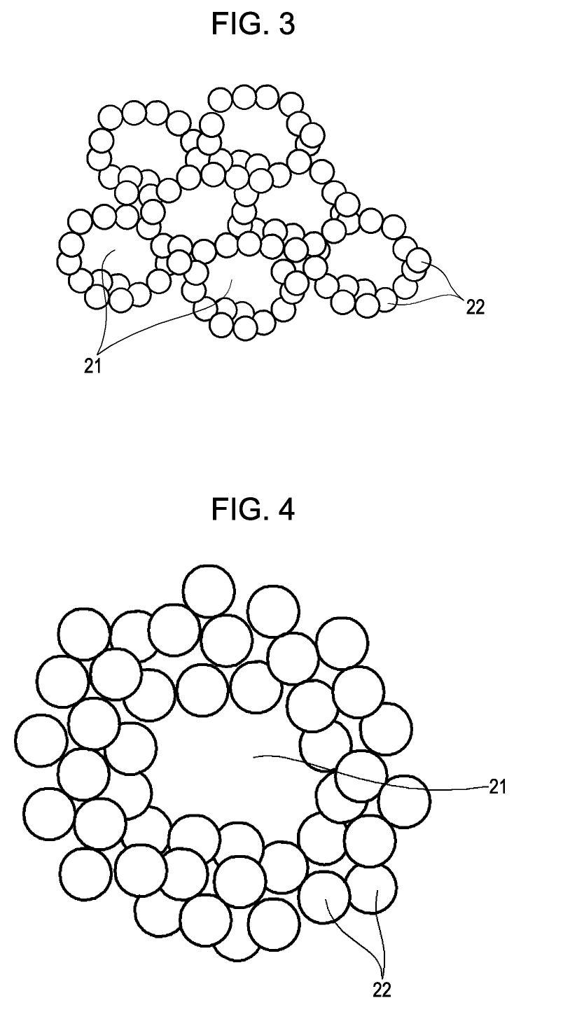

The fluorescent layer 20 is formed of a transparent synthetic resin material, such as an epoxy resin, a polyallylamine (PAA), or a silicone resin, and fluorescent particles 21 mixed therewith. As shown in FIG. 3, a plurality of fluorescent particles 21 agglomerates to form agglomerates, and a plurality of the agglomerates is mixed in the synthetic resin material. In addition, in the synthetic resin material, some of the fluorescent particles 21 may be separately present from each other.

The fluorescent particles 21 absorb light emitted from the semiconductor light emitting element 10, and internal molecules are excited by the absorbed light, so that light having a wavelength different from that of the absorbed light is emitted. In this embodiment, the fluorescent particles 21 are formed of a YAG fluorescent substance and emit yellow light since being excited by the light emitted from the semiconductor light emitting element 10. The average particle diameter of the fluorescent particles 21 is approximately 5 to 20 μm.

As shown in FIGS. 3 and 4, transparent fine particles 22 adhere to the outside of each fluorescent particle 21. The transparent fine particles 22 are formed, for example, of silica (SiO₂), titanium oxide (TiO₂), or aluminum-sapphire, and the average particle diameter is in the range of 50 to 200 nm. The fine particles 22 adhere to the periphery of each fluorescent particle 21 to form a plurality of layers. The bond between the fine particles 22 and the fluorescent particles 21 and the bond between the fine particles 22 are formed by mechanical bonding or mechanical chemical bonding. The mechanical bonding is to bond between the fluorescent particles 21 and the fine particles 22 and between the fine particles 22 with an intermolecular bonding force generated by mixing and stirring many fluorescent particles 21 and many fine particles 22 while a friction force is being applied thereto. The mechanical chemical bonding is to bond between the fluorescent particles 21 and the fine particles 22 and between the fine particles 22 with an intermolecular bonding force generated by applying plasma energy thereto besides the application of a friction force to many fluorescent particles 21 and many fine particles 22.

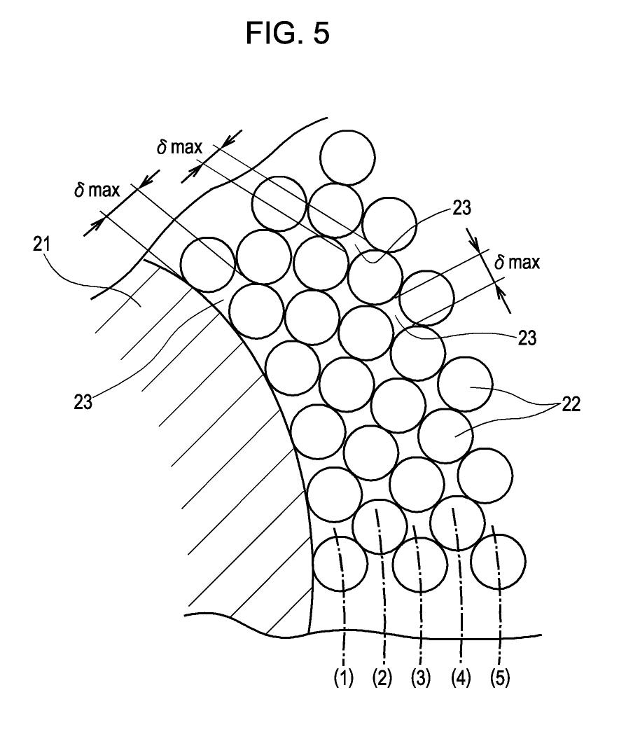

FIG. 5 is an enlarged schematic view of a bond portion between one fluorescent particle 21 and the fine particles 22.

Since many fine particles 22 adhere to the outside of the fluorescent particle 21, between the fluorescent particle 21 and the fine particles 22 and between the fine particles 22, a plurality of air layers 23 is formed. The air layers 23 each function as a heat insulating layer, and when the outside temperature is increased, the temperature of the fluorescent particle 21 is suppressed from being increased. When the air layers 23 are each made to function as a heat insulating layer, almost all air layers 23 are preferably formed in respective closed spaces, that is, the peripheries thereof are each preferably closed. Incidentally, the mean free path of a nitrogen molecule under the atmospheric pressure (1 atmospheric pressure) is approximately 100 nm or is slightly smaller than that. Hence, when the maximum spatial length δmax of one air layer 23 is 100 nm or less, the transmission of heat in the air layer 23 can be decreased, and hence the heat insulating effect of the air layer 23 can be enhanced. In addition, the ratio of the number of air layers having a maximum spatial length δmax of 100 nm or less with respect to that of all the air layers 23 is preferably 50% or more and more preferably 80% or more. Furthermore, it is more preferable that 50% or more or 80% or more of the air layers 23 have a maximum spatial length δmax of 80 nm or less.

After a mixed liquid formed by mixing the fluorescent particles 21 and the fine particles 22 shown in FIG. 3 in a transparent synthetic resin material is supplied on the semiconductor light emitting element 10 and the reflection surface 4a, shown in FIG. 1, the synthetic resin material is cured by a heat treatment, so that the fluorescent layer 20 is formed. In the fluorescent layer 20 thus cured, the ratio of the fluorescent particles 21 and the fine particles 22 in terms of volume ratio is preferably approximately 20 to 50 percent by volume.

In this light emitting device 1, when a voltage is applied across the lead terminals 5 and 6, and a forward current is supplied to the semiconductor light emitting element 10, blue or blue base light is emitted therefrom. In this embodiment, a blue light having a wavelength of 460 to 470 nm is emitted. In addition, the fluorescent particles 21 absorb the above light and are excited thereby, so that yellow or yellow base light is emitted. Since the blue or blue base light passing through the layer of the synthetic resin material and the yellow or yellow base light emitted from the fluorescent particles 21 are synthesized, white or white base color is emitted from the light emitting device 1.

When a relatively large current is supplied to the semiconductor light emitting element 10 in order to emit light having a high output, the semiconductor light emitting element 10 is heated, and this heat is transmitted to the fluorescent layer 20. In addition, when the use environment temperature is increased, the fluorescent layer 20 is heated to a high temperature. When the temperature of the fluorescent particles 21 formed of a YAG fluorescent substance or the like is increased, the luminous efficiency is decreased, and as a result, as for the light emitted from the light emitting device 1, the quantity of light emitted from the fluorescent particles 21 is decreased with respect to the quantity of light emitted from the semiconductor light emitting element 10; hence, the chromaticity and the color temperature of light synthesized between the above two types of light are liable to vary. However, in the light emitting device 1, as shown in FIGS. 3 to 5, since many air layers 23 are present along the peripheries of the fluorescent particles 21 and each function as a heat insulating layer, an increase in temperature of the fluorescent particles 21 can be suppressed. Furthermore, since the fluorescent particles 21 agglomerate in the fluorescent layer 20, an increase in temperature of the fluorescent particles 21 can be suppressed. Hence, a decrease in luminous efficiency of the fluorescent particles 21 can be suppressed, and as a result, the variation in chromaticity and color temperature of light emitted from the light emitting device 1 can be suppressed.

### EXAMPLES

### Example

In the light emitting device 1 of the example, as the semiconductor light emitting element 10, an element emitting blue light having a wavelength 460 to 470 nm was used. As the fluorescent particles 21, a YAG fluorescent substance having an average particle diameter of 8 μm was used, and as the fine particles 22, silica (SiO₂) having an average particle diameter of 0.1 μm was used. By using “Nano-particle composite production system (Model: NC-LAB-P)” manufactured by Hosokawa Micron Group, the fluorescent particles 21 and the fine particles 22 were processed to form a composite.

The bonding state between the fluorescent particles 21 and the fine particles 22, which formed the composite, was observed by a scanning electron microscope (SEM), and it was confirmed that the fine particles 22 adhered to the outsides of the fluorescent particles 21 to form five layers on an average, and that the maximum spatial length δmax of each air layer 23 was in the range of 50 to 60 nm. FIG. 5 is a schematic view showing the state in which five layers of the fine particles 22 adhered to the outside of the fluorescent particle 21. In FIG. 5, (1) indicates a first layer of fine particles 22, and (2), (3), (4), and (5) indicate a second layer, a third layer, a fourth layer, and a fifth layer of fine particles 22, respectively.

After the fluorescent particles 21 provided with the fine particles 22 which adhered to the outsides thereof were mixed in a pre-cured epoxy resin and were then stirred in a ball mill, a liquid thus stirred was potted on the surface of the semiconductor light emitting element 10, and the epoxy resin was cured by a heat treatment, so that the fluorescent layer 20 was formed. The ratio of the fluorescent particles 21 and the fine particles 22 in the mixed liquid including the pre-cured epoxy resin, the fluorescent particles 21, and the fine particles 22 was set to 50 percent by weight. In addition, after the cured fluorescent layer 20 was cut off, the cross-section thereof was observed by a scanning electron microscope, and it was confirmed that almost all fluorescent particles 21 agglomerated to each other. In addition, it was also confirmed that the thickness dimension from the light emitting surface of the semiconductor light emitting element 10 to the surface of the fluorescent layer 20 was 100 μm.

### Comparative Example

The same light emitting device as that in the above example was used for the comparative example except that the fluorescent particles 21 were not provided with the fine particles 22 so that the fluorescent layer was formed only from the epoxy resin and the fluorescent particles. The ratio of the fluorescent particles 21 in the mixed liquid of the epoxy resin and the fluorescent particles 21 was set to the same as that in the above example. In addition, the thickness of the fluorescent layer was set to the same as that of the above example.

### Evaluation

### (a) Evaluation Method A

Forward currents of 1 mA, 5 mA, 20 mA, 50 mA, and 100 mA were supplied to the light emitting devices of the example and the comparative example, and the changes, on the chromatic coordinates, in light emitted from the devices of the example and the comparative example were measured at the respective currents by a color meter.

### (b) Evaluation Method B

When a forward current of 20 mA was supplied to the light emitting device of each of the example and the comparative example, and the environment temperatures were stabilized at −40° C., −30° C., 0° C., 25° C., 50° C., and 85° C., the changes, on the chromatic coordinates, of light emitted from the devices of the example and the comparative example were measured by a color meter.

### Evaluation Results

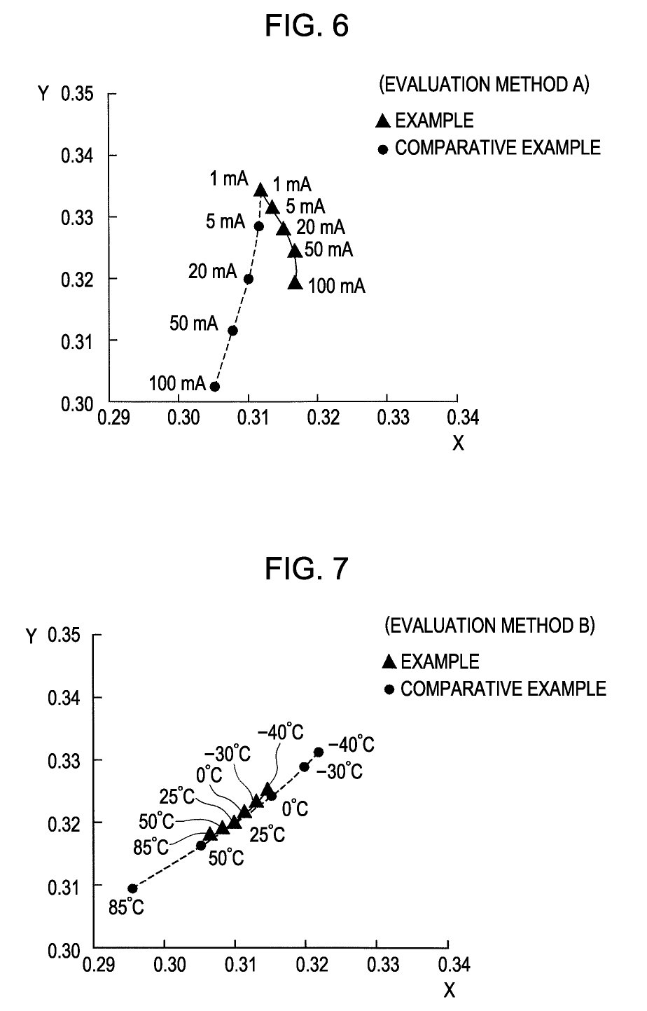

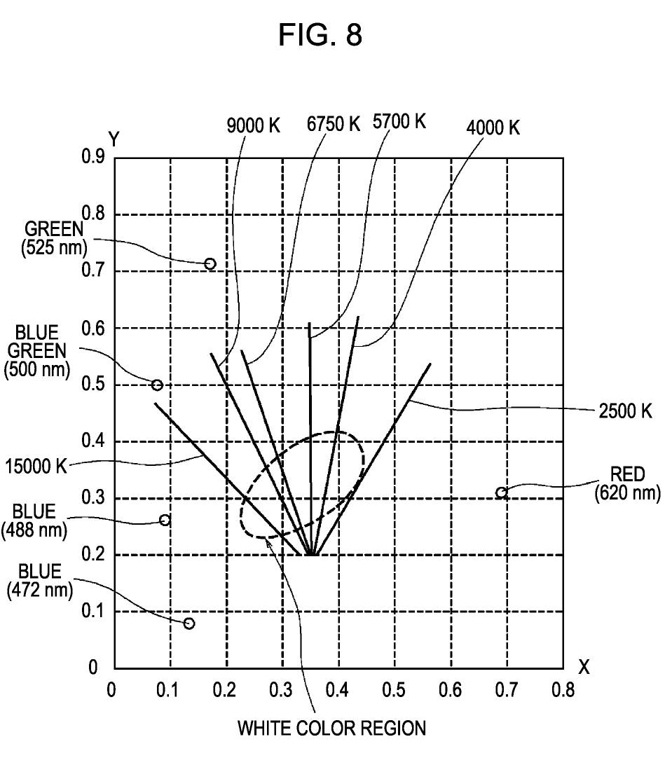

FIG. 6 shows the evaluation results obtained by the evaluation method A, and FIG. 7 shows the evaluation results obtained by the evaluation method B. In both FIGS. 6 and 7, the black triangles show measurement results of the chromaticity of the example, and the small black circles show measurement results of the chromaticity of the comparative example.

FIGS. 6 and 8 each show a chromaticity diagram in which the horizontal axis is indicated by X and the vertical axis is indicated by Y. FIG. 8 shows the overall chromaticity diagram for reference. In the chromaticity diagram shown in FIG. 8, the coordinate positions of light having respective wavelengths are shown. A region surrounded by a dotted line located at the lower left of the center is a white color region. In addition, in the chromatic coordinates, the radial solid line indicates the color temperatures of white color and white base color. The color temperature is shown by K (Kelvin), a higher color temperature indicates white or white base color having a cold feeling, and as the color temperature decreases, white or white base color having a warmer feeling is obtained.

According to the evaluation method A shown in FIG. 6, it was found that in the comparative example, the change in color of light with the change in current was in a wide range, and that on the other hand, in the example, it was in a narrow range. It was also found that in the example, as the current was increased, the luminance was slightly changed. However, in the example, the coordinate direction in which the color was changed was a direction in which the color temperature was not changed or a direction in which the color temperature slightly decreased as the current was increased.

Accordingly, in the example, when a large current is supplied to the semiconductor light emitting element, the color temperature of luminescent color can be suppressed from being increased, and the state in which light having a cold feeling is emitted can be suppressed.

According to the evaluation method B shown in FIG. 7, it was found that as for the change in luminescent color on the chromatic coordinates with the change in use environmental temperature, the amount of change of the example is smaller than that of the comparative example.

What is claimed is:

1. A light emitting device comprising:
a semiconductor light emitting element;
electrodes supplying electricity to the semiconductor light emitting element; and
a fluorescent layer covering a light emitting side of the semiconductor light emitting element,
wherein the fluorescent layer includes:
fluorescent particles emitting light by light emitted from the semiconductor light emitting element;
transparent fine particles which adhere to the outsides of the fluorescent particles, and
air layers formed between the fluorescent particles and the fine particles and between the fine particles.

2. The light emitting device according to claim 1,
wherein the air layers have a spatial length of 100 nm or less.

3. The light emitting device according to claim 1,
wherein the fluorescent particles provided with the fine particles which adhere to the outsides thereof agglomerate in at least a part of the fluorescent layer.

4. The light emitting device according to claim 1,
wherein the fluorescent layer further includes a transparent synthetic resin besides the fluorescent particles and the fine particles.

5. The light emitting device according to claim 1,
wherein with an intermolecular bonding force generated by applying mechanical energy, the fluorescent particles and the fine particles are bonded together, and the fine particles are bonded to each other.

6. The light emitting device according to claim 1,
wherein the semiconductor light emitting element emits blue light, and the fluorescent particles emit yellow light.

7. The light emitting device according to claim 1,
wherein the air layers have a spatial length of 100 nm or less,
the fluorescent particles provided with the fine particles which adhere to the outsides thereof agglomerate in at least a part of the fluorescent layer,
the fluorescent layer further includes a transparent synthetic resin besides the fluorescent particles and the fine particles, and
with an intermolecular bonding force generated by applying mechanical energy, the fluorescent particles and the fine particles are bonded together, and the fine particles are bonded to each other.

8. The light emitting device according to claim 1,
wherein the air layers have a spatial length of 100 nm or less,
the fluorescent particles provided with the fine particles which adhere to the outsides thereof agglomerate in at least a part of the fluorescent layer,
the fluorescent layer further includes a transparent synthetic resin besides the fluorescent particles and the fine particles,
with an intermolecular bonding force generated by applying mechanical energy, the fluorescent particles and the fine particles are bonded together, and the fine particles are bonded to each other, and
the semiconductor light emitting element emits blue light, and the fluorescent particles emit yellow light.
